(19) United States
(12) Patent Application Publication
(10) Pub. No.: US 2013/0310547 A1
(43) Pub. Date: Nov. 21, 2013

(54) RARE EARTH METAL COMPLEX

(71) Applicant: Takeshi Yamashita, Tsukuba-shi (JP)

(72) Inventor: Takeshi Yamashita, Tsukuba-shi (JP)

(73) Assignee: Hitachi Chemical Company, Ltd.

(21) Appl. No.: 13/989,763

(22) PCT Filed: Nov. 16, 2011
(86) PCT No.: PCT/JP2011/076434

§ 371 Date: Aug. 5, 2013

(30) Foreign Application Priority Data
Nov. 29, 2010 (JP) 2010-265214

(51) Int. Cl. C07F 5/00

(52) U.S. Cl. CPC C07F 5/00
USPC 534/15

(57) ABSTRACT

Provided is a rare earth metal complex including a rare earth metal atom and a β-diketone compound coordinated to the rare earth metal atom, the β-diketone compound being represented by the following Formula (1). In Formula (1), R represents a monovalent aromatic hydrocarbon group or a monovalent aromatic heterocyclic group.

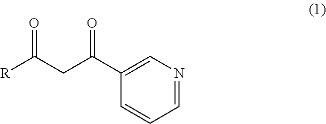

### TECHNICAL FIELD

The present invention relates to a rare earth metal complex.

### BACKGROUND ART

Conventionally, various rare earth-based light emitting materials are known. In lighting apparatuses and display apparatuses, light emitting devices are used in which light of a discharge lamp or a semiconductor light emitting element is color-converted with a fluorescent material.

In recent years, particularly, fluorescent materials using a rare earth metal complex has been expected to be applied in a variety of fields in terms of having high solubility in solvents and high dispersibility in resin, unlike inorganic fluorescent materials. For example, there have been proposed various applications of fluorescent materials, such as fluorescent probes, bioimaging, ink for printing, sensors, wavelength conversion resin sheet, and lightning.

As a light emitting mechanism of a rare earth metal complex, there is known a mechanism in which a ligand absorbs light and the excitation energy thereof is transferred to a rare earth metal ion as a light emission center to excite the ion, thereby emitting light.

From the viewpoint of the application range of fluorescent materials, extension of excitation wavelength has been desired. However, changing the skeleton of the ligand to extend the excitation wavelength has sometimes reduced energy transfer efficiency between the ligand and the metal and therefore practically sufficient light emission intensity has not been obtainable.

In relation to the above circumstances, for example, Japanese Patent Application Laid-Open (JP-A) No. 2005-252250 has proposed a rare earth metal complex that can be excited by a longer wavelength than in conventional rare earth metal complexes by sufficiently reducing impurities, crystal defects, and deactivation due to energy trapping in the process of energy transfer from ligand.

In addition, for example, JP-A-2009-46577 has proposed a rare earth metal complex that can be excited at a longer wavelength than in conventional rare earth metal complexes by reacting a rare earth metal complex coordinated by phosphine oxide with a siloxane bond-containing compound to activate the f-f transition of a rare earth metal.

### SUMMARY OF INVENTION

### Technical Problem

However, in the rare earth metal complex described in JP-A-2005-252250, light emission intensity has sometimes been insufficient. Additionally, in some cases, it has been hard to say that the rare earth metal complex described in JP-A-2009-46577 has high general versatility, in terms of requiring hydro silicone as an essential ingredient.

In view of the problems, it is an object of the present invention to provide a rare earth metal complex that can be excited by excitation light having a longer wavelength than in the conventional rare earth metal complexes and has high light emission intensity.

### Solution to Problem

The present invention includes the following aspects.

<1> A rare earth metal complex including a rare earth metal atom and a β-diketone compound coordinated to the rare earth metal atom, the β-diketone compound being represented by the following Formula (1).

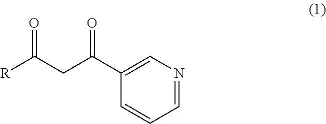

(In Formula (1), R represents a monovalent aromatic hydrocarbon group or a monovalent aromatic heterocyclic group).

<2> The rare earth metal complex according to the <1>, in which the rare earth metal complex has a maximum absorption at a wavelength of 350 nm or more and has a light emission efficiency of 30% or more at an excitation wavelength of 400 nm.

<3> The rare earth metal complex according to the <1> or <2>, represented by the following Formula (2).

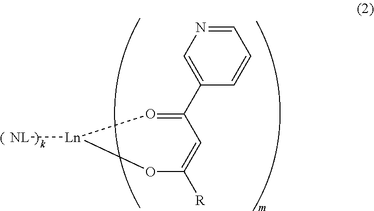

(In Formula (2), Ln represents a rare earth metal atom; NL represents a neutral ligand; R represents a monovalent aromatic hydrocarbon group or a monovalent aromatic heterocyclic group; k represents an integer form 1 to 5; and m represents an integer equal to a valence of Ln.)

<4> The rare earth metal complex according to any one of the <1> to <3>, in which the rare earth metal atom is europium (Eu), terbium (Tb), erbium (Er), ytterbium (Yb), neodymium (Nd), or samarium (Sm).

According to the present invention, there can be provided a rare earth metal complex that can be excited by excitation light having a longer wavelength than in the conventional rare earth metal complexes and has high light emission intensity.

### BRIEF DESCRIPTION OF DRAWINGS

FIG. 1 is a view illustrating an example of maximum absorption spectra of rare earth metal complexes obtained in an Example and Comparative Examples of the present invention.

FIG. 2 is a view illustrating an example of excitation spectra of the rare earth metal complexes obtained in Examples and a Comparative Example of the present invention.

FIG. 3 is a view illustrating an example of an enlarged view of light emission spectra of the rare earth metal complexes obtained in the Example and the Comparative Example of the present invention in a wavelength range of 550 to 750 nm under excitation light of 400 nm.

### DESCRIPTION OF EMBODIMENTS

A rare earth metal complex according to the present invention is a complex including a rare earth metal atom and a β-diketone compound coordinated to the rare earth metal atom, the β-diketone compound being represented by the following formula (1).

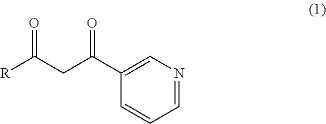

In Formula (1) above, R represents a monovalent aromatic hydrocarbon group or a monovalent aromatic heterocyclic group that may have a substituent.

The aromatic hydrocarbon group is preferably an aromatic hydrocarbon group having 6 to 22 carbon atoms, and more preferably an aromatic hydrocarbon group having 6 to 14 carbon atoms. In addition, the aromatic hydrocarbon group may be condensed with an aliphatic ring.

Additionally, a numerical range represented by “to” as used herein means a range including numerical values before and after “to” as a minimum value and a maximum value, respectively.

Specific examples of the aromatic hydrocarbon group include a phenyl group, a naphthyl group, an anthranyl group, a phenanthrenyl group, a pyrenyl group, a perylenyl group, [symbol] a tetrecenyl group, a chrysenyl group, a pentacenyl group, a triphenylenyl group, an indenyl group, an azulenyl group, a fluorenyl group, and the like.

The aromatic heterocyclic group is preferably a 5- to 18-membered aromatic heterocyclic group, and also preferably, a 5- to 9-membered aromatic heterocyclic group may be additionally fused together to form an aromatic heterocyclic group as a whole. Examples of a heteroatom forming the aromatic heterocyclic group include a nitrogen atom, an oxygen atom, a sulfur atom, and the like. The aromatic heterocyclic group preferably includes at least one selected from a nitrogen atom, an oxygen atom, and a sulfur atom. The number of heteroatoms forming the aromatic heterocyclic group is not particularly limited, but preferably 1 to 3, and more preferably 1 to 2.

The aromatic heterocyclic group is, from the viewpoint of excitation wavelength and light emission intensity, preferably an aromatic heterocyclic group including a 5- to 6-membered aromatic heterocyclic group having 1 to 3 of at least one kind of heteroatom selected from a nitrogen atom, an oxygen atom, and a sulfur atom.

Specific examples of the aromatic heterocyclic group include a pyrrolyl group, a thienyl group, a furyl group, an imidazolyl group, a pyrazolyl group, a pyridyl group, a pyridazinyl group, a pyrimidinyl group, a pyrazinyl group, a triazolyl group, a triazinyl group, a thiazolyl group, an isothiazolyl group, an oxazolyl group, an isoxazolyl group, an indolyl group, an isoindolyl group, a benzofuryl group, an isobenzofuryl group, a benzoxazolyl group, an isobenzoxazolyl group, a benzothiazolyl group, a benzothienyl group, a carbazolyl group, and the like.

The monovalent aromatic hydrocarbon group and the monovalent aromatic heterocyclic group represented by R may be each unsubstituted or may each have an substituent. In the case of having a substituent, examples of the substituent include an alkyl group, an alkoxy group, a halogen group, a perfluoroalkyl group, a nitro group, an amino group, a sulfonyl group, a cyano group, a silyl group, a phosphone group, a diazo group, a mercapto group, an aryl group, an aralkyl group, an aryloxy group, an aryloxycarbonyl group, an allyl group, an acyl group, an acyloxy group, and the like. From the viewpoint of the extension of excitation wavelength and the light emission intensity, preferred is at least one selected from the group consisting of an alkyl group, an alkoxy group, a halogen group, and a perfluoroalkyl group, and more preferred is at least one selected from the group consisting of an alkyl group having 1 to 4 carbon atoms, an alkoxy group having 1 to 4 carbon atoms, and a perfluoroalkyl group having 1 to 3 carbon atoms.

More specifically, preferred is at least one selected from the group consisting of a methyl group, an ethyl group, a propyl group, an isopropyl group, a butyl group, a methoxy group, an ethoxy group, a propoxy group, an isopropoxy group, a butoxy group, a trifluoromethyl group, a pentafluoroethyl group, and a heptafluoropropyl group; more preferred is at least one selected from the group consisting of a methyl group, an ethyl group, a propyl group, an isopropyl group, a methoxy group, an ethoxy group, a propoxy group, an isopropoxy group, trifluoromethyl group, a pentafluoroethyl group, and a heptafluoropropyl group; and still more preferred is at least one selected from the group consisting of a methyl group, an ethyl group, a propyl group, an isopropyl group, a methoxy group, an ethoxy group, a propoxy group, and an isopropoxy group.

In case of the aromatic hydrocarbon group and the aromatic heterocyclic group represented by R have a substituent, the number of substituents is not particularly limited. It is preferable to have 1 to 5 substituents; it is more preferable to have 1 to 3 substituents; and it is still more preferable to have 1 to 2 substituents.

In addition, when the aromatic hydrocarbon group and the aromatic heterocyclic group represented by R have a substituent, the substitution position of the substituent is not limited. For example, when the aromatic hydrocarbon group represented by R is a phenyl group, the substituent may be substituted at any of the ortho, meta, or para position, and more preferably, the group has the substituent at the para position.

The aromatic hydrocarbon group and the aromatic heterocyclic group represented by R are, from the viewpoint of the extension of excitation wavelength and the light emission intensity, preferably a thienyl group, an alkyl group-containing thienyl group, a benzothienyl group, a carbazolyl group, a naphthyl group, a phenyl group, an alkyl group-containing phenyl group, an alkoxyl group-containing phenyl group, a halogen atom-containing phenyl group, a haloalkyl group-containing phenyl group, an alkyl group-containing pyrrolyl group, a phenanthrenyl group, or a fluorenyl group, more preferably a thienyl group, a naphthyl group, or a phenyl group, and still more preferably a thienyl group or a phenyl group.

The followings are specific examples of the β-diketone compound represented by Formula (1). However, the present invention is not limited thereto.

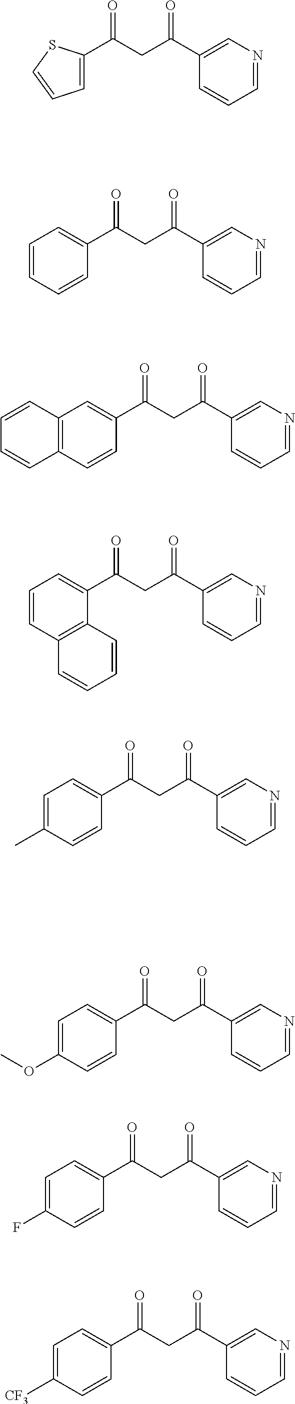

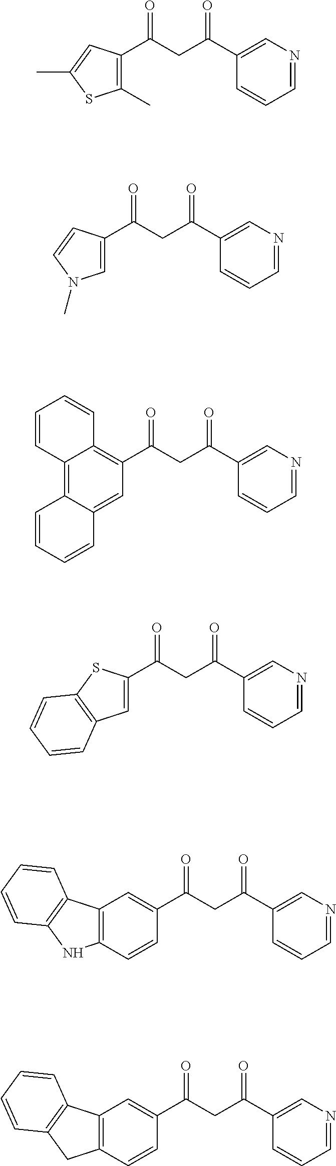 [SMILES: Cc1cc(C(=O)CC(=O)c2cccnc2)c(C)s1 ; Cn1ccc(C(=O)CC(=O)c2cccnc2)c1 ; O=C(CC(=O)c1cc2ccccc2c2ccccc12)c1cccnc1 ; O=C(CC(=O)c1cc2ccccc2s1)c1cccnc1 ; O=C(CC(=O)c1ccc2[nH]c3ccccc3c2c1)c1cccnc1 ; O=C(CC(=O)c1ccc2c(c1)-c1ccccc1C2)c1cccnc1]

The β-diketone compound represented by Formula (1) can be obtained, for example, as indicated by the following reaction formula, by condensing an aromatic ketone with nicotinate (for example, methyl nicotinate) in the presence of a base. In the following formula, R represents an aromatic hydrocarbon group or an aromatic heterocyclic group, and R′ represents an alkyl group (preferably, an alkyl group having 1 to 4 carbon atoms), an aryl group, or the like.

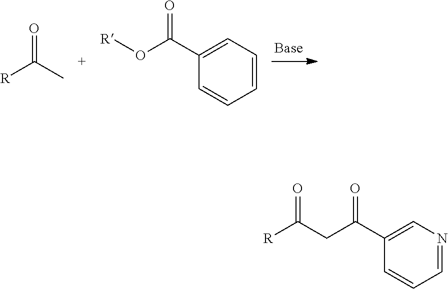

The rare earth metal atom included in the rare earth metal complex of the present invention is, from the viewpoint of the wavelength of light emission and the light emission intensity, preferably at least one selected from the group consisting of europium (Eu), terbium (Tb), erbium (Er), ytterbium (Yb), neodymium (Nd), or samarium (Sm), more preferably Eu, Sm, or Tb, and particularly preferably Eu.

The rare earth metal complex including a β-diketone compound as a ligand according to the present invention is not limited as long as a total number of coordination to the rare earth metal atom is from 6 to 9. Examples of such complexes include a complex in which three molecules of β-diketonate as an anion with a valence of −1 are coordinated to a rare earth metal ion with a valence of +3, and a complex in which a Lewis basic neutral ligand is coordinated, as an auxiliary ligand, to the above-described complex, or a complex including four coordinated β-diketonate molecules and a cationic molecule for neutralizing a total valence. Particularly, considering dispersibility in a medium and fluorescent properties as the fluorescent material, preferred is a complex including the three molecules of a β-diketonate compound coordinated to a rare earth metal and a neutral ligand as a Lewis basic.

The rare earth metal complex of the present invention is, from the viewpoint of the wavelength of light emission and the light emission intensity, preferably a complex represented by the following Formula (2):

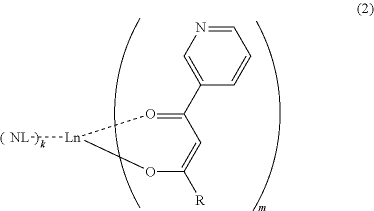

In Formula (2), Ln represents a rare earth metal atom; NL represents a neutral ligand; R represents a monovalent aromatic hydrocarbon group or aromatic heterocyclic group that may have a substituent; k represents an integer of from 1 to 5; and m represents an integer equal to a valence of Ln.

In Formula (2), examples of the rare earth metal atom represented by Ln include the rare earth metal atoms mentioned above, and suitable rare earth metal atoms are also the same as those above.

The R in Formula (2) has the same definition as the R in Formula (1) and the preferable range thereof is also the same as the range of the R in Formula (1).

The neutral ligand represented by NL is not particularly limited as long as the ligand can be coordinated to the rare earth metal atom Ln. Examples of the neutral ligand include compounds including a nitrogen atom, an oxygen atom, or a sulfur atom. Specific examples thereof include amine compounds, amine oxide compounds, phosphine oxide compounds, ketone compounds, sulfoxide compounds, ether compounds, and the like. These compounds are used alone or in combination of two or more thereof.

In addition, when Ln represents Eu³⁺, the neutral ligand is selected such that the total coordination number of the Eu³⁺ is 7, 8, or 9.

Examples of the amine compounds represented by the neutral ligand NL include pyridine, pyradine, quinoline, isoquinoline, 2,2′-bipyridine, 1,10-phenanthroline, derivatives thereof having a substituent, and the like.

Examples of the amine oxide compounds represented by the neutral ligand NL include N-oxides of the amine compounds, such as pyridine-N-oxide, isoquinoline-N-oxide, 2,2′-bipyridine-N,N′-dioxide, and 1,10-phenanthroline-N,N′-dioxide, and derivatives thereof having a substituent.

Examples of the phosphine oxide compounds represented by the neutral ligand NL include alkylalkyl phosphine oxides such as triphenylphosphine oxide, triethylphosphine oxide, and trioctylphosphine oxide, 1,2-ethylenebis (diphenylenephosphine oxide), (diphenylphosphineimide)triphenylphosphorane, triphenyl phosphate, derivatives thereof havng a substituent, and the like.

Examples of the ketone compounds represented by the neutral ligand NL include dipyridylketone, benzophenone, derivatives thereof having a substitutent, and the like.

Examples of the sulfoxide compounds represented by the neutral ligand NL include diphenyl sulfoxide, dibenzyl sulfoxide, dioctyl sulfoxide, derivatives thereof having a substitutent, and the like.

Examples of the ether compounds represented by the neutral ligand NL include ethylene glycol dimethyl ether, ethylene glycol dimethyl ether, derivatives thereof having a substitutent, and the like.

In Formula (2), k represents an integer form 1 to 5, preferably an integer from 1 to 3, and more preferably an integer from 1 to 2.

In Formula (2), m represents an integer equal to a valence of Ln. For example, when Ln represents Eu³⁺, m representes 3.

In Formula (2), when the rare earth metal atom Ln represents Eu, the neutral ligand NL represents preferably at least one selected from the group consisting of an amine compound, a phosphine oxide compound, and a sulfoxide compound, more preferably an amine compound or a phosphine oxide compound, and still more preferaly an amine compound. In addition, among amine compounds, preferred is a neutral ligand NL represented by the following Formula (3):

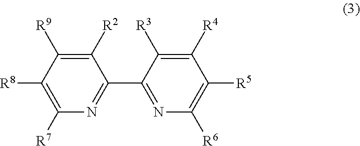

In Formula (3), R² to R⁹ each independentaly represent a hydrogen atom, an alkyl group, or an aryl group. In addition, R² and R³, R³ and R⁴, R⁴ and R⁵, R⁵ and R⁶, R⁷ and R⁸, R⁸ and R⁹, and R⁹ and R², respectively, may bond to each other to form a ring.

The neutral ligand represented by the Formula (3) may be a bipyridine compound in which R² and R³ each independently represent a hydrogen atom or a phenathroline compound in which R² and R³ bond to each other to form a benzene ring.

R² to R⁹ in Formula (3) each independently preferably represent a hydrogen atom or an alkyl group or phenyl group having 1 to 9 carbon atoms, more preferably represent a hydrogen atom, a methyl group, an ethyl group, or a phenyl group, and still more preferably a hydrogen atom, a methyl group, or a phenyl group.

When any of R⁴ to R⁹ in Formula (3) represents an alkyl group or an aryl group, at least R⁵ or R⁸ (namely, the 5-position) represents preferably an alkyl group or an aryl group.

Supecific examples of the neutral ligand NL represented by Formula (3) include, preferably, 2,2′-bipyridine, 1,10-phenanthroline, basophenanthroline, neocuproine, basocuproine, 5,5′-dimethyl-2,2′-bipyridine, 4,4′-dimethyl-2,2′-bipyridine, 6,6′-dimethyl-2,2′-bipyridine, 5-phenyl-2,2′-bipyridine, 2,2′-biquinoline, 2,2′-bi-4-lepidine, 2,9-dibutyl-1, 10-phenathroline, 3,4,7,8-tetramethyl-1,10-phenanthroline, and 2,9-dibutyl-1,10-phenathroline, and more suitably 2,2′-bipyridine, 1,10-phenanthroline, basophenanthroline, 5,5′-dimetyl-2,2′-bipyridine, and 5-phenyl-2,2′-bipyridine.

In addition, in Formula (2), when the rare earth metal atom Ln represents Eu, k represents preferably an integer from 1 to 2, and more preferably an interger of 1.

The rare earth metal complex of the present invention can be prepared by an usual method. For example, the rare earth metal complex of the invention can be easily obtained by reacting a rare earth metal compound with a β-diketone compound in the presence of a base.

The rare earth metal compound used to manufacture the rare earth metal complex is not particularly limited. Examples of the rare earth metal compound include inorganic compounds of rare earth metals, such as oxides, hydroxides, sulfides, fluorides, chlorides, bromides, iodides, sulfates, sulfites, disulfates, hydrogen sulfates, thiosulfates, nitrates, nitrites, phosphates, phosphites, hydrogen phosphates, dihydrogen phosphates, diphosphates, polyphosphates, (hexa)fluorophosphates, carbonates, hydrogen carbonates, thiocarbonates, cyanides, thiocyanides, borates, (tetra)fluoroborates, cyanates, thiocyanates, isothyanates, azides, nitrides, borides, silicates, (hexa)fluorosilicates, isopolyacids, heteropolyacids, and other condensed polyacid salts, and organic compounds thereof, such as alcoholates, thiolates, amides, imides, carboxylates, sulfonates, phosphonates, phosphinates, amino acid salts, carbamates, and xanthogenates.

The rare earth metal complex of the present invention has a maximum absorption wavelength of preferably 350 nm or more, more preferably from 350 to 400 nm, and still more preferably from 355 to 375 nm.

The maximum absorption wavelength of the rare earth metal complex of the present invention is a wavelength attributable to the β-diketone compound. In a state in which the β-diketone compound has been coordinated to the rare earth metal atom, the absorption wavelength of an anion of the β-diketone compound, namely, a β-diketonate, is observed. To shift toward longer absorption wavelength of the β-diketonate, it is desirable to extend a conjugated system.

The maximum absorption wavelength of the rare earth metal complex of the present invention is measured in a solution prepared such that the absorbance is 1.0 or less in a rectangular quartz cell with an optical path length of 1 cm using a commercially available spectrophotometer (for example, U-3310 manufactued by Hitachi High-Tech Fielding Corporation). A desirable solvent for the measurement is a solvent having high sample solubility and low absorption in UV range. Examples of such a solvent include tetrahydrofuran, dimethylformaldehyde, and the like. Additionally, sample concentration for the measurement is appropriately selected according to the molar absorption coefficient of each sample and is preferably adjusted such that the absorbance is in a range of from 0.1 to 1.0.

Specifically, in the present invention, the maximum absorption wavelength represents a value measured using dimethylformaldehyde as the solvent at a concentration of 2×10⁻⁵ [M].

Additionally, the rare earth metal complex of the present invention has a maximum excitation wavelength of preferably from 395 to 450 nm, more preferably from 400 to 440 nm, and still more preferably from 405 to 435 nm.

The maximum excitation wavelength of the rare earth metal complex of the present invention is measured by fixing the wavelength of a fluorescence side spectroscope (particularly when the light emission center is made of Eu³⁺, the wavelength is appropriately adjusted in a range of from 605 to 620 nm representing a maximum light emission intensity) and scanning the wavelength of an excitation side spectroscope, using a commercially available spectrofluorophotometer (for example, F-4500, manufactured by Hitachi High-Technologies Corporatoin). The shape of the samples is selected from powder, solution, a state of having been dispersed in resin, and the like. The sample shape is not limited to any form in a relative comparison. Additionally, careful attention is required since samples in a powder state scatter and samples in a state of solution or being dispersed in resin are affected by a medium or show dependency on the concentration of the medium.

Specifically, the maximum excitation wavelength in the present invention represents a value measured using dimethylformamide as the solvent at a concentration of 1×10⁻⁴ [M].

Furthermore, the rare earth metal complex of the present invention has preferably a light emission efficiency of 30% or more, more preferably 35% or more, and still more preferably 40% or more, at an excitation wavelength of 400 nm.

Description will be given of a method for obtaining the light emission efficiency and the light emission intensity of the rare earth metal complex of the present invention.

A rare earth metal complex as a measurement object (phosphor sample) is placed in an integrating sphere provided with a spectrophotometer and an excitation light source and irradiated with light of 400 nm from the excitation light emission light source to perform measurement. Such a measurement apparatus is a QEMS 2000 manufactured by Systems Engineering or the like. The reason for using the integrating sphere or the like is to allow the addition of all of photons reflected from the phosphor sample and photons released from the phosphor sample by photoluminescence.

In the measurement spectrum, actually, in addition to the photons released from the phosphor sample by photoluminescence excited with light from the excitation light emission light source, the contribution of the photons of excitation light reflected from the phosphor sample overlaps. In other words, the light emission efficiency is defined as a value obtained by dividing a total numer of photons released by photoluminescence of the phosphor sample by a total number of photons of excitation light absorbed by the phosphor sample.

In addition, when the excitation light intensity is set to a constant level, the light emission intensity is defined as a sum of the number of photons released by photoluminescence of the sample. Additionally, when the central metal is a europium ion (Eu³⁺), the interval of integration may be a wavelength range of 550 to 750 nm including 600 to 630 nm derived from a transition from 5D0 to 7F2 which is a wavelength range of the most intense light emission.

The use of the rare earth metal complex of the present invention is not particularly limited. Examples of the use thereof include light-emitting probes, bioimaging, ink for printing, sensors, wavelength-converting resin sheet, lighting, and the like.

In addition, the rare earth metal complex of the present invention may be used, for example, as a resin sealing spherical fluorescent material by dispersing in resin or dissolving in a vinyl monomer for suspension polymerization, as well as may be applied to a wavelength-converting resin composition used on the light receiving surface side of a solar cell, a wavelength conversion type solar cell sealing material (wavelength conversion type solar cell sealing sheet), and solar cell modules using these components. For example, by using the rare earth metal complex of the present invention for these applications, light of a wavelength range less contributive to photovoltaic power generation is wavelength-converted to light of a wavelength range greatly contributive to photovoltaic power generation, thereby improving power generation efficiency.

### EXAMPLES

Given hereinbelow is a detailed description of the present invention with reference to Examples. The invention, however, is not limited thereto. Additionally, “part(s)” and “%” are based on mass unless otherwise specified.

### Example 1

### Synthesis of 3Py2TP (1-(3-pyridyl)-3-(2-thienyl)-1,3-propanedione)

An amount of 1.92 g (0.08 mol) of sodium hydride was weighed out, and under a nitrogen atmosphere, 45 ml of dehydrated tetrahydrofuran was added. While strongly stirring the mixture, a solution of 5.05 g (0.04 mol) of 2-acetylthiophene and 6.58 g (0.048 mol) of methyl nicotinate dissolved in 50 ml of dehydrated tetrahydrofuran was added dropwise in 1 hour. Subsequently, the resulting mixture was subjected to reflux for 8 hours. The reaction solution was returned to room temperature, 20 g of pure water was added, and furthermore, 16.5 ml of 3 mol/L hydrochloric acid was added. The organic layer was separated and concentrated under reduced pressure. The concentrate was recrystallized to obtain 7.35 g (a yield o79%) of a β-diketone compound, 3Py2TP as light yellow powder.

### Synthesis of Eu(3Py2TP)₃Phen

In 25.0 g of methanol were dispersed 518.1 mg (2.24 mmol) of 3Py2TP synthesized as described above and 151.4 mg (0.84 mmol) of 1,10-phenanthroline (Phen). To the dispersion was added a solution of 112.0 mg (2.80 mmol) of sodium hydroxide dissolved in 10.0 g of methanol, and the mixture was stirred for 1 hour.

Next, a solution of 256.5 mg (0.7 mmol) of europium (III) chloride hexahydrate dissolved in 5.0 g of methanol was added dropwise into the mixture. After stirring the resulting mixture at room temperature for 1 hour, the mixture was heated to 60° C. in an oil bath and continuously stirred for more 2 hours. The reaction solution was returned to room temperature and the produced precipitate was suction-filtrated, washed with methanol, and then dried to obtain 530.6 mg of Eu(3Py2TP)₃Phen.

### Example 2

### Synthesis of P3PyP (1-phenyl-3-(3-pyridyl)-1,3-propanedione)

An amount of 1.92 g (0.08 mol) of sodium hydride was weighed out, and under a nitrogen atmosphere, 45 ml of dehydrated tetrahydrofuran was added. While strongly stirring the mixture, a solution of 4.81 g (0.04 mol) of acetophenone and 6.58 g (0.048 mol) of methyl nicotinate dissolved in 50 ml of dehydrated tetrahydrofuran was added dropwise in 1 hour. Subsquently, the resulting mixture was subjected to reflux for 8 hours. The reaction solution was returned to room temperature, 20 g of pure water was added, and furthermore, 14.0 ml of 3 mol/L hydrochloric acid was added. The organic layer was separated and concentrated under reduced pressure. The concentrate was recrystallized to obtain 6.20 g (a yield of 69%) of a β-diketone compound, P3PyP as light yellow powder.

### Synthesis of Eu(P3PyP)₃Phen

In 25.0 g of methanol were dispersed 504.6 mg (2.24 mmol) of P3PyP synthesized as described above and 151.4 mg (0.84 mmol) of 1,10-phenanthroline (Phen). To the dispersion was added a solution of 112.0 mg (2.80 mmol) of sodium hydroxide dissolved in 10.0 g of methanol, and the mixture solution was stirred for 1 hour.

Next, a solution of 256.5 mg (0.7 mmol) of europium (III) chloride hexahydrate dissolved in 5.0 g of methanol was added dropwise into the mixture. After stirring the resulting mixture at room temperature for 1 hour, the mixture solution was heated to 60° C. in an oil bath and continusouly stirred for more 2 hours. The reaction solution was returned to room temperature and the produced precipitate was suction-filtrated, washed with methanol, and then dried to obtain 418.2 mg of Eu(P3PyP)₃Phen.

### Example 3

### Synthesis of 2N3PyP (1-(2-naphthyl)-3-(3-pyridyl)-1,3-propanedione)

An amount of 1.92 g (0.08 mol) of sodium hydride was weighed out, and under a nitrogen atmosphere, 45 ml of dehydrated tetrahydrofuran was added. While strongly stirring the mixture, a solution of 6.81 g (0.04 mol) of 2-acetonaphthone and 6.58 g (0.048 mol) of methyl nicotinate dissolved in 50 ml of dehydrated tetrahydrofuran was added dropwise in 1 hour. Subsequently, the resulting mixture was subjected to reflux for 8 hours. The reaction solution was returned to room temperature, 20 g of pure water was added, and furthermore, 14.0 ml of 3 mol/L hydrochloric acid was added. The organic layer was separated and concentrated under reduced pressure. The concentrate was recrystallized to obtain 9.45 g (a yield of 86%) of a β-diketone compound, 2N3PyP as yellow powder.

### Synthesis of Eu(2N3PyP)₃Phen

In 25.0 g of methanol were dispersed 639.1 mg (2.24 mmol) of 2N3PyP synthesized as described above and 151.4 mg (0.84 mmol) of 1,10-phenanthroline (Phen). To the dispersion was added a solution of 112.0 mg (2.80 mmol) of sodium hydroxide dissolved in 10.0 g of methanol, and the mixture solution was stirred for 1 hour.

Next, a solution of 256.5 mg (0.7 mmol) of europium (III) chloride hexahydrate dissolved in 5.0 g of methanol was added dropwise into the mixture. After stirring the resulting mixture at room temperature for 1 hour, the mixture solution was heated to 60° C. in an oil bath and continuously stirred for more 2 hours. The reaction solution was returned to room temperature and the produced precipitate was suction-filtrated, washed with methanol, and then dried to obtain 739.4 mg of Eu(2N3PyP)₃Phen.

### Comparative Example 1

### Synthesis of Eu(TTA)₃Phen

To 11 g of sodium hydroxide (1M) was added a solution of 2.00 g (9.00 mmol) of thenoyltrifluoroacetone (TTA) dissolved in 75.0 g of ethanol. Next, a solution of 0.62 g (3.44 mmol) of 1,10-phenathroline dissolved in 75.0 g of ethanol was added, and the mixture solution was continuously stirred for 1 hour.

Next, a solution of 1.03 g (2.81 mmol) of europium (III) chloride hexahydrate dissolved in 20.0 g of ethanol was added dropwise to the mixture solution, and the resulting solution was continously stirred for 1 more hour. The produced precipitate was suction-filtrated, washed with ethanol, and dried to obtain 2.33 g of a rare earth metal complex, Eu(TTA)₃Phen.

### Comparative Example 2

### Synthesis of Eu(BFA)₃Phen

To 11 g of sodium hydroxide (1M) was added a solution of 1.94 g (9.00 mmol) of benzoyltrifluoroacetone (BFA) dissolved in 60.0 g of ethanol. Next, a solution of 0.62 g (3.44 mmol) of 1,10-phenathroline dissolved in 60.0 g of ethanol was added, and the mixture solution was continuously stirred for 1 hour.

Next, a solution of 1.03 g (2.81 mmol) of europium (III) chloride hexahydrate dissolved in 20.0 g of ethanol was added dropwise to the mixture solution, and the resulting solution was continously stirred for 1 more hour. The produced precipitate was suction-filtrated, washed with ethanol, and then dried to obtain 2.22 g of a rare earth metal complex, Eu(BFA)₃Phen.

### Comparative Example 3

### Synthesis of Eu(DBM)₃Phen

To 11 g of a sodium hydroxide aqueous solution (1M) was added a solution of 2.00 g (9.00 mmol) of dibenzoylmethane (DBM) dissolved in 60.0 g of ethanol. Next, a solution of 0.62 g (3.44 mmol) of 1,10-phenathroline dissolved in 60.0 g of ethanol was added, and the mixture solution was continuously stirred for 1 hour.

Next, a solution of 1.03 g (2.81 mmol) of europium (III) chloride hexahydrate dissolved in 20.0 g of ethanol was added dropwise to the mixture solution, and the resulting solution was continously stirred for 1 more hour. The produced precipitate was suction-filtrated, washed with ethanol, and dried to obtain 2.48 g of a rare earth metal complex, Eu(DBM)₃Phen.

[Measurement Methods]

The following is a description of methods for measuring individual parameters, such as excitation wavelengths, measured regarding the rare earth metal complexes obtained above.

1. Measurement of Maximum Absorption Wavelength

Using the spectrophotometer, a U-3310 manufactured by Hitachi High-Tech Fielding Corporation, the maximum absorption wavelength was measured at the concentration of 2×10⁻⁵ [M] using dimethylformaldehyde as the solvent.

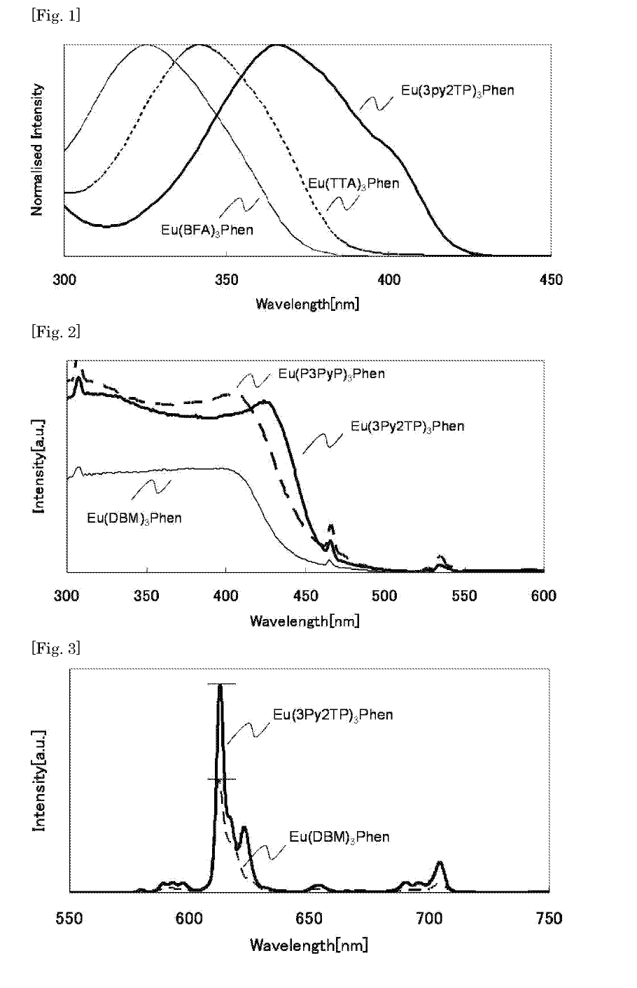

FIG. 1 illustrates the maximum absorption wavelengths of the rare earth metal complexes obtained in Example 1 and Comparative Examples 1 and 2.

2. Measurement of Maxiumum Excitation Wavelength

Using the spectrofluorophotometer, an F-4500 manufactured by Hitachi High-Technologies Corporatoin, the maximum excitation wavelength was measured at the concentration of 1×10⁻⁴ [M] using dimethylformaldehyde as the solvent.

FIG. 2 illustrates the excitation spectra of the rare earth metal complexes obtained in Examples 1 and 2, and Comparative Example3.

3. Measurement of Light Emission Intensity and Light Emission Efficiency

The measurements were performed using, as a light emisission quantum effciency measuring apparatus, a QEMS-2000 manufactured by Systems Engineering Inc. Samples were each irradiated with excitation light of 400 nm to measure light emission efficiency as a value obtained by dividing a total numer of photons released by photoluminescence of the sample by a total number of photons of the excitation light absorbed by the sample. In addition, in the light emission spectrum thereof, the total number of photons in an integral interval of 550 to 750 nm was defined as a light emission intensity.

FIG. 3 illustrates an enlarged view of light emission spectra of the rare earth metal complexes obtained in Example 1 and Comparative Example 3 in the wavelength range of 550 to 750 nm under the excitation light of 400 nm.

TABLE 1

| | | Maximum | Maximum | | Light |
|---|---|---|---|---|---|
| | | absorption | excitation | Light | emission |
| | Rare earth metal | wavelength | wavelength | emission | efficiency |
| | complex | (nm) | (nm) | intensity | (%) |
| Example 1 | Eu(3Py2TP)₃Phen | 366 | 427 | 113 | 50 |
| Example 2 | Eu(P3PyP)₃Phen | 355 | 416 | 70 | 41 |
| Example 3 | Eu(2N3PyP)₃Phen | 363 | 429 | 69 | 36 |
| Comparative | Eu(TTA)₃Phen | 342 | 391 | 100 | 67 |
| Example 1 | | | | | |
| Comparative | Eu(BFA)₃Phen | 325 | 375 | 74 | 62 |
| Example 2 | | | | | |
| Comparative | Eu(DBM)₃Phen | 353 | 415 | 61 | 29 |
| Example 3 | | | | | |

As seen in Table 1, it is apparent that the rare earth metal complexes of the present invention according to Examples 1 to 3 including the β-diketone compound represented by Formula (1) as the ligand have been excited by excitation light having longer wavelengths than in the rare earth metal complexes of Comparative Examples 1 to 2 that do not include the β-diketone compound represented by Formula (1) as the ligand. In addition, as compared to Comparative Example 3 including, as the ligand, the β-diketone compound other than the the β-diketone compound represented by Formula (1), higher light emission intensity is observed.

The disclosure of Japanese Patent Application No. 2010-265214 is incorporated herein by reference in its entirety. All literatures, patent applications and technical standards described in the present specification are herein incorporated by reference to the same extent as if each individual literature, patent application and technical standard was specifically and individually indicated as being incorporated by reference.

1. A rare earth metal complex comprising:
a rare earth metal atom; and
a β-diketone compound coordinated to the rare earth metal atom, the β-diketone compound being represented by the following Formula (1): 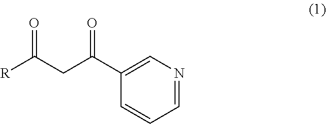
wherein, in Formula (1), R represents a monovalent aromatic hydrocarbon group or a monovalent aromatic heterocyclic group.

2. The rare earth metal complex according to claim 1, wherein the rare earth metal complex has a maximum absorption at a wavelength of 350 nm or more and has a light emission efficiency of 30% or more at an excitation wavelength of 400 nm.

3. The rare earth metal complex according to claim 1, represented by the following Formula (2): 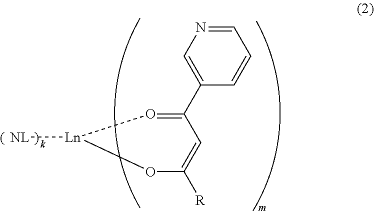
wherein, in Formula (2), Ln represents a rare earth metal atom; NL represents a neutral ligand; R represents a monovalent aromatic hydrocarbon group or a monovalent aromatic heterocyclic group; k represents an integer of from 1 to 5; and m represents an integer equal to a valence of Ln.

4. The rare earth metal complex according to claim 1, wherein the rare earth metal atom is europium (Eu), terbium (Tb), erbium (Er), ytterbium (Yb), neodymium (Nd), or samarium (Sm).

5. The rare earth metal complex according to claim 2, represented by the following Formula (2): 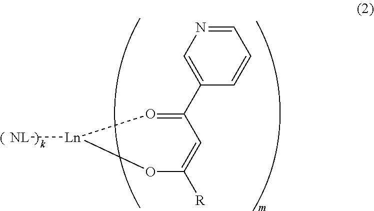
wherein, in Formula (2), Ln represents a rare earth metal atom; NL represents a neutral ligand; R represents a monovalent aromatic hydrocarbon group or a monovalent aromatic heterocyclic group; k represents an integer of from 1 to 5; and m represents an integer equal to a valence of Ln.

6. The rare earth metal complex according to claim 5, wherein the rare earth metal atom is europium (Eu), terbium (Tb), erbium (Er), ytterbium (Yb), neodymium (Nd), or samarium (Sm).

7. The rare earth metal complex according to claim 2, wherein the rare earth metal atom is europium (Eu), terbium (Tb), erbium (Er), ytterbium (Yb), neodymium (Nd), or samarium (Sm).

8. The rare earth metal complex according to claim 3, wherein the rare earth metal atom is europium (Eu), terbium (Tb), erbium (Er), ytterbium (Yb), neodymium (Nd), or samarium (Sm).
